(19) United States
(12) Patent Application Publication
(10) Pub. No.: US 2006/0169170 A1
(43) Pub. Date: Aug. 3, 2006

(54) Anti-corrosive agent for heat-exchange mechanism

(76) Inventor: Satoshi Endoh, Aichi (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 11/127,220

(22) Filed: May 12, 2005

(30) Foreign Application Priority Data
May 12, 2004 (JP) 2004-142172

(51) Int. Cl. C04B 9/02; C04B 9/00

(52) U.S. Cl. 106/14.05; 106/14.21; 106/14.44

(57) ABSTRACT

An anti-corrosive agent for preventing corrosion of a heat exchange mechanism composed of a copper pipe for flowing heat exchange medium therethrough and a radiative member made of metal different from the copper pipe in quality and assembled in contact with the copper pipe for radiating heat transmitted from the copper pipe, the anti-corrosive agent containing phenol-modified epoxy resin paint and aluminum powder as main components in a condition where the aluminum powder is uniformly mixed in the epoxy resin paint.

### BACKGROUND OF THE INVENTION

1. Field of the Invention

The present invention relates to an anti-corrosive agent for preventing a heat exchange mechanism from corrosion.

2. Discussion of the Prior Art

In a heat exchange mechanism in a refrigerator, a freezer, an air conditioner etc., there is provided a heat exchanger composed of plurality of aluminum fins assembled in contact with the outer periphery of a copper pipe to cause heat exchange between refrigerant flowing through the copper pipe and an outside air or an inside air. In such a heat exchanger, the copper pipe and aluminum fins are corroded when exposed to corrosive gases broke out in the cabinet of the refrigerator or corrosive gases included in the outside air for a long period of time. The copper pipe and aluminum fins are also corroded due to potential difference thereof, and the corrosion of them becomes noticeable in humid environment. The heat exchange mechanism installed in the refrigerator, freezer or ice making chamber is composed of partition walls made of stainless steal assembled in contact with the copper pipe for radiation of heat transmitted therefrom. The partition walls are involved in corrosive problem described above.

Disclosed in Japanese Patent Laid-open Publication No. 58-136995 is a heat exchange mechanism for solution of the foregoing problems. In the heat exchange mechanism, a heat exchanger is coated thereon with an anti-corrosive agent containing resin component to block contact with corrosive gases and humid air for preventing the occurrence of corrosion. The resin layer formed on the outer surface of the heat exchanger is, however, inferior in heat conductivity less than metal, resulting in deterioration of heat change efficiency. For this reason, the surface of the resin layer is rugged to adhere fine particles of metal therein.

As the anti-corrosive agent is in the form of resin paint containing polyacryl resin, the resin layer formed on the surfaces of the heat exchanger is damaged in its specific molecular structure when exposed to drops of dew containing corrosive gases such as hydrogen sulfide and acetic acid. As a result, the resin layer is locally broken and damaged in its function for blocking corrosive gases and humid air.

### SUMMARY OF TILE INVENTION

It is, therefore, a primary object of the present invention to provide an anti-corrosive agent capable of restraining fatigue of a resin membrane formed on the surface of the heat exchange mechanism and caused by corrosive gases in drops of dew and for restraining deterioration of heat exchange efficiency caused by formation of the resin membrane.

According to the present invention, the object is accomplished by providing an anti-corrosive agent for preventing corrosion of a heat exchange mechanism composed of a copper pipe for flowing heat exchange medium therethrough and a radiative member made of metal different from the copper pipe in quality and assembled in contact with the copper pipe for radiating heat transmitted from the copper pipe, the anti-corrosive agent containing phenol-modified epoxy resin paint and aluminum powder as main components in a condition where the aluminum powder is uniformly mixed in the epoxy resin paint. In a practical embodiment of the present invention, it is preferable that the anti-corrosive agent contains acetylacetone metallic salt acting as a surface-active agent.

In a condition where the anti-corrosive agent was coated on the surface of the heat exchange mechanism, a resin membrane is formed by phenol-modified epoxy resin paint mixed with aluminum powder. In the resin membrane, a layer of phenol-modified epoxy resin paint is effective to block permeation of corrosive gases and humid air into the surface of the heat exchange mechanism, and the aluminum powder mixed in the layer of epoxy resin acts to prevent the copper pipe from corrosion caused by permeation of drops of dew containing corrosive components into the resin layer.

In the resin membrane, the phenol-modified epoxy resin acts as a binder for retaining the aluminum powder in an arranged condition. In the principal chain of molecular structure of the resin paint, there is ether linkage replaced with ester likage. The ether linkage in the principal chain of molecular structure is effective to resist corrosive components of hydrogen sulfide gas, acetic acid gas, etc. since it is superior in waterproof property and anti-drug property in contract with ester linkage. Thus, the resin membrane is effective to block permeation of water containing corrosive components and is retained without being locally damaged. The aluminum powder in the resin membrane is effective to enhance heat conductivity of the resin membrane for preventing deterioration of the heat exchange efficiency.

In another practical embodiment of the present invention, there is provided an anti-corrosive agent for preventing corrosion of a heat exchange mechanism composed of a copper pipe for flowing heat exchange medium therethrough and a radiative member made of metal different from the copper pipe in quality and assembled in contact with the copper pipe for radiating heat transmitted from the copper pipe, the anti-corrosive agent containing phenol-modified epoxy resin paint, benzotriazol and aluminum powder as main components in a condition where the aluminum powder and benzotriazol are uniformly mixed in the epoxy resin paint. In this embodiment, it is preferable that the anti-corrosive agent contains acetylacetone metallic salt as a surface-active agent. The benzotriazol in the anti-corrosive agent is effective to enhance the anti-corrosive performance of the resin membrane since it is a chemical substance extremely effective for preventing the copper pipe from corrosion.

### BRIEF DESCRIPTION OF THE DRAWINGS

In the drawings:

FIG. 1 is a schematic illustration of a heat exchange mechanism equipped with a heat exchanger coated with an anti-corrosive agent according to the present invention;

FIG. 2 is a front view of the heat exchanger shown in FIG. 1;

FIG. 3 is a sectional view of a peripheral wall portion of a refrigerator having a cooling mechanism coated with the anti-corrosive agent according to the present invention;

FIG. 4 is a sectional view of a resin layer formed by coating of the anti-corrosive agent according to the present invention; and

FIG. 5 is a sectional view of a resin layer formed by coating of a conventional anti-corrosive agent.

### DESCRIPTION OF THE PREFERRED EMBODIMENTS

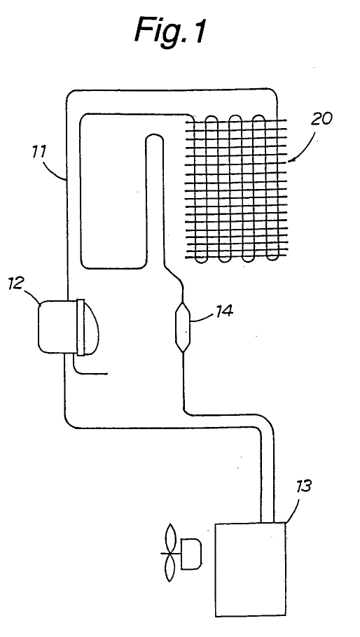

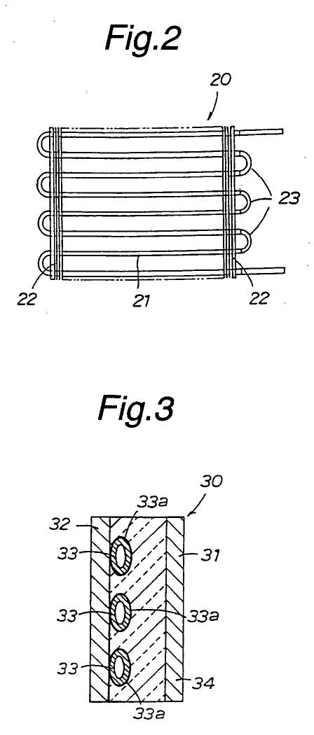

An anti-corrosive agent according to the present invention is suitable for use as a paint to prevent corrosion of a heat exchange mechanism schematically illustrated in the FIG. 1. The heat exchange mechanism comprises a heat exchanger 20 connected to a freezing circuit 10. The heat exchanger 20 is installed as a cooler in a cabinet of a refrigerator or a freezer to cool the interior of the cabinet by heat exchange with refrigerant circulating therein. The freezing circuit 10 comprises a compressor 12, a condenser 13 and an expansion valve 14 disposed in a circulation conduit 11 of refrigerant. The heat exchanger 20 is interposed between the expansion valve 14 and compressor 12 in the freezing circuit 10. As shown in FIG. 2, the heat exchanger 20 is composed of a plurality of aluminum fins 22 assembled in contact with a plurality of copper pipes 21. The copper pipes 21 are connected in parallel with each other by means of U-shaped bent pipes 23 welded to their opposite ends to form a refrigerant conduit.

The heat exchanger 20 is usually exposed to various corrosive gases broken out from foodstuffs in the cabinet of the refrigerator or freezer. For example, when boiled eggs or backed eggs are stored in the cabinet, there will occur corrosive gases containing sulfur such as hydrogen sulfide. When vinegar, dough, mayonnaise, etc. are stored in the cabinet, there will occur corrosive gases containing acetic acid. In the case that the heat exchanger is installed outside the cabinet of the refrigerator or freezer, it will be corroded when exposed to corrosive gases containing hydrogen sulfide, acetic acid, etc.

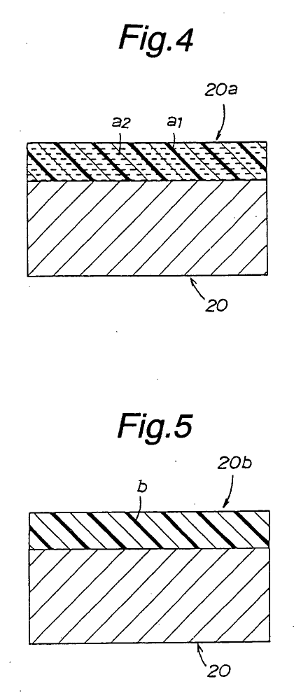

To prevent the heat exchanger from corrosion caused by the corrosive gases, the copper pipes 21 and aluminum fins 22 of the heat exchanger are coated thereon with an anti-corrosive agent of the present invention and covered with a resin membrane formed by the anti-corrosive agent as shown in FIG. 4. Illustrated in FIG. 5 is a resin membrane formed by coating of a conventional anti-corrosive agent.

In FIG. 3, there is illustrated a portion of another heat exchange mechanism coated with the anti-corrosive agent of the present invention. This heat exchange mechanism comprises a spiral copper pipe 33 disposed within a peripheral wall of a refrigerator which is formed with insulation material such as foamed urethane filled in a space between an exterior plate 31 and an interior plate 32. The copper pipe is arranged in contact with the interior plate 32. In the heat exchange mechanism, the interior of the refrigerator is cooled by heat exchange of the interior plate 32 with refrigerant supplied to the copper pipe 33. The anti-corrosive agent of the present invention is suitable to form a resin membrane 33a of the surface of the copper pipe 33.

The anti-corrosive agent of the present invention contains aluminum powder uniformly mixed with phenol-modified epoxy resin paint. In a practical embodiment of the present invention, the anti-corrosive agent is in the form of anti-corrosive paint of 1—liquid thermosetting type containing 70-80 parts epoxy resin as a primary agent, 20-30 parts phenol resin as a curing agent, 10-30 parts aluminum powder. Preferably, 0.1-1.5 parts acetylacetone metallic salt is added to the mixture of the elements as a surface-active agent.

In another practical embodiment of the present invention, the anti-corrosive agent contains phenol-modified epoxy resin paint, benzotriazol and aluminum flake as main components. In the anti-corrosive agent, aluminum powder is uniformly mixed with phenol-modified epoxy resin paint and benzotriazol. The anti-corrosive agent is in the form of an anti-corrosive agent of I-liquid thermosetting type cotaining 70-80 parts epoxy resin as a primary agent, 20-30 parts phenol resin as a curing agent, 10-30 parts aluminum powder and 0.1-1.5 parts benzotriazol. Preferably, 0.1-1.5 parts acetylacetone metallic salt is added to the mixture of the elements as a surface-active agent.

In the foregoing embodiments, phenol-modified epoxy resin clear without any pigment (Orga: 1000Hclear:made by Nippon Paint K.K.) can be used as the phenol-modified epoxy resin paint commonly contained in the anti-corrosive agent. It is preferable that the aluminum powder commonly contained in the anti-corrosive agent is several μm—several 10 μm in mean particle diameter, for example, in the form of aluminum flake of 5 μm in mean particle diameter (Al—S NO. 22000: made by Daiwa Metal Powder Kogyo K.K.) or aluminum flake of 33 μm in mean particle diameter (Al—S NO. 600: made by Daiwa Metal Powder Kogyo K.K.).

As shown in FIG. 4, the anti-corrosive agent of the present invention is coated on the component parts of the heat exchanger 20 to form a resin membrane 20a. In the resin membrane 20a, aluminum powder (aluminum flake) a2 is uniformly mixed in a resin layer 1a mainly formed by phenol-modified epoxy resin paint. In contrast with the resin membrane 20a, illustrated in FIG. 5 is a resin membrane 20b formed by coating a conventional anti-corrosive agent on the component parts of the heat exchanger 20 in which only a resin layer b is formed by phenol denatured epoxy resin clear.

In the resin membrane 20a shown in FIG. 4, the resin layer 1a is effective to block contact of corrosive gases and humid air with the surface of the heat exchanger 20, and the aluminum powder (aluminum flakes) a2 is effective to block permeation of drops of dew containing corrosive gases into the resin layer a1. Additionally, the aluminum powder (aluminum flakes) acts as a sacrificial anode to the copper pipe 21 of the heat exchanger 20 to prevent the copper pipe 21 from corrosion caused by permeation of the drops of dew into the resin layer.

In the resin membrane 20a, the resin paint forming the resin layer a1 acts as a binder for uniformly retaining the aluminum powder (aluminum flakes) a2. In the principal chain of molecular structure of the resin paint, there is ether linkage replaced with ester linkage. The ether linkage in the principal chain of molecular structure is effective to resist corrosive components of hydrogen sulfide gas, acetic acid gas, etc. since it is superior in waterproof property and anti-drug property in contrast with ester linkage. Thus, the resin membrane 20a is effective to block permeation of water containing corrosive components and is retained without being locally damaged and coming off from the surface of the heat exchanger 20.

In the resin membrane 20a, the aluminum powder (aluminum flakes) acts as a quasi-electrode to prevent corrosion caused by potential difference of radiation fins 22 of aluminum and to enhance heat conductivity of the resin membrane for preventing deterioration of the heat exchange efficiency. In the resin membrane formed by the anti-corrosive agent containing benzotriazol, corrosion of the copper pipe 21 of heat exchanger 20 is effectively prevented by bensotriazol contained in the resin layer 1a1. This is effective to enhance anti-corrosive effects to the heat exchanger 20.

Experiments:

Experiments were carried out to ascertain the anti-corrosive effect of the anti-corrosive agent of the present invention in contrast with a conventional anti-corrosive agent used heretofore in general. In each experiment, a heat exchanger 20 was coated with a sample of an anti-corrosive agent to form a resin membrane (20a, 20b) thereon and installed in a cabinet of a refrigerator. To ascertain a corroded condition of the heat exchanger and leakage of gas from the same, the refrigerator was operated for a long period of time in a condition where the cabinet was filled with corrosive gas of a predetermined concentration. A result of the experiments is shown in the following table 1.

A sample agent 1 corresponds with the anti-corrosive agent in the practical embodiment of the present invention, which is in the form of a baking finish containing 70 wt % phenol-modified epoxy resin paint and 30 wt % aluminum flakes as main components and added with 1.5 wt % acetylacetone metallic salt. A sample agent 2 corresponds with the anti-corrosive agent in the other practical embodiment of the present invention, which is in the form of a baking finish containing 70 wt % phenol-modified epoxy resin paint, 30 wt % aluminum powder and 1 wt % benzotriazol as main components and added with 1.5 wt % acetylacetone metallic salt. A sample agent 3 is in the form of a conventional baking finish containing phenol-modified epoxy resin clear as a main component.

The phenol-modified epoxy resin paint in the sample agents 1 and 2 is “Orga 1000H clear” which essentially consists of 60.5 wt % epoxy resin varnish, 31.7 wt % epoxy soluble phenol resin varnish, 7.6 wt % solvent and 0.2 t % addition agent. The solvent is in the form of a mixture of toluene (15-20 w %), n-butyl alcohol (5-10 wt %), isobutyl alcohol (5-10 w %) and diacetone alcohol (15-20 wt %).

The aluminum powder in the sample agents 1 and 2 is in the form of aluminum powder (Al—S No. 22000) made by Daiwa Metallic Powder Kogyo K.K. The aluminum powder is in the form of scale shaped aluminum flakes of 5 μm in mean particle diameter essentially consisting of 99.3 wt % Al, 0.7 wt % (Fe+Si), 0.1 wt % CuO and 0.15 wt % (Mn+Mg+Zn). The aluminum powder may be replaced with aluminum powder (Al—S NO. 600: made by Daiwa Metallic Powder Kogyo K.K.) of 33 μm in mean particle diameter.

The acetylacetone metallic salt in the sample agents is in the form of Al(C₅H₇O₂)₃ made by Nippon Kagaku Sangyo K.K. To stabilize a dispersed condition of the aluminum powder, about 5.5 wt % acetylacetone metallic salt was added to the aluminum powder. The addition amount of acetylacetone metallic salt may be reduced to about 1.0 wt %.

Formation of Resin Membrane:

Formation of resin membrane on surface of the heat exchanger 20 was carried out by coating the sample agents and baking the coated sample agents at 180° C. for twenty minutes. Hereinafter, the resin membrane formed by the sample agent 1 is referred to a resin membrane 20a1, the resin membrane formed by the sample agent 2 is referred to a resin membrane 20a2, and the resin membrane formed by the sample agents is referred to a resin membrane 20b. The thickness of respective resin membranes 20a1, 20a2, 20b was defined in an extent of 30-50 μm.

Working Condition of Refrigerator:

Heat exchangers 20 covered with the resin membranes 20a1, 20a2, 20b were respectively installed in a cabinet of a refrigerator and operated for a long period of time in a condition where the cabinet was filled with corrosive gases (hydrogen sulfide of about 6 ppm in concentration+acetic acid of 1 ppm in concentration). To form atmosphere of corrosive gases (hydrogen sulfide gas+acetic acid gas), beakers filled with two kinds of solution were used as a source of corrosive gases and stored in the cabinet of the refrigerator. Provided that, the beakers were replaced with beakers filled with fresh solutions at each lapse of about 200 hours in operation. To maintain the interior of the cabinet in an appropriate humid condition, a beaker filled with water of 100 g was stored together with the breakers in the cabinet of the refrigerator.

For assumption of corrosive gases caused by boiled eggs, sulfurous spring, etc., atmosphere of hydrogen sulfide gas was formed in the cabinet of the refrigerator. To provide a source of hydrogen sulfide gas, sodium sulfide of 24 g was solved in water of 100 g stored in a beaker of 500 mL, and ammonium dihydrogenphosphate of 5.44 g was solved in the aqueous solution in a condition where the sodium sulfide was completely solved.

For assumption of corrosive gases caused by vinegar, dough, mayonnaise, etc., glacial acetic acid of 10 g was completely solved in water of 90 g stored in a beaker of 500 mL to provide a source of acetic acid gas.

Test Itmes at Experiments:

As test times at the experiments, three items were determined to externally ascertain a corroded condition of the heat exchanger 20, to ascertain a period of time during which the heat exchanger 20 becomes inoperative for cooling, and to ascertain a period of time during which leakage of gases occurs in the heat exchanger 20.

The external observation of the heat exchanger 20 was made by taking pictures of the heat exchanger before cooling operation of the refrigerator and every the days 16, 44 and 203 after start of cooling operation of the refrigerator. The inoperative condition of the heat exchanger for cooling was ascertained based on detection of temperatures of a cooling device in the refrigerator and the interior of the cabinet. To visually ascertain leakage of gases, nitrogen gas under pressure of 1 MPa was entered into the interior of the heat exchanger coated with cheking liquid. The cooling operation of the refrigerator was stopped when the cooling deficiency and leakage of gases in the heat exchanger was ascertained.

Result of Experiments:

In operation of the refrigerator, it has been found that each heat exchanger 20 was corroded under the atmosphere of excessive corrosive gases in the cabinet. The corrosion of each heat exchanger 20 was ascertained by black and green color adhesion caused by corrosion. The corrosion appeared at adjacent return-bent portions at distal end sides of the component parts and a defrost heater portion. At the end of cooling operation, the corrosion was expanded approximately at the entirety of the return-bent portions and defrost heater portion.

A difference in corrosive degree has been found in the respective heat exchangers 20 in accordance with the number of days of cooling operation. In the heat exchangers 20 covered with the resin membrane 20a1, 20a2, it has been found that the degree of corrosion was less than that in the heat exchanger covered with the resin membrane 20b formed by the conventional anti-corrosive agent. The evaluation of an obtained result is shown in the following table 1.

The result of the observation was evaluated at four steps of ⊚, ◯, Δ, X. The character ⊚ represents a condition where any corrosion did not appear in the heat exchanger, the character ◯ represents a condition where local corrosion in a low degree appeared in the heat exchanger, the character Δ represents a condition where corrosion in a medium degree appeared in entirety of the heat exchanger immediately before leakage of gases, and the character X represents a condition where corrosion in a high degree appeared in entirety of the heat exchanger to cause leakage of gases.

TABLE 1

| | | Resin membrane | | |
|---|---|---|---|---|
| | Number of days | 20a1 | 20a2 | 20b |
| Appearance | Before operation | ⊚ | ⊚ | ⊚ |
| | Day 16 | ◯ | ◯ | Δ |
| | Day 44 | Δ | Δ | X |
| | Day 203 | X | Δ | — |

In the heat exchanger 20 formed thereon with the resin membrane 20a1, cooling deficiency and leakage of gases were found at the day 203 after start of operation. In the heat exchanger 20 formed thereon with the resin membrane 20b, cooling deficiency and leakage of gases were found at the day 44 after start of operation. In the heat exchanger 20 formed thereon with the resin membrane 20a2, any cooling deficiency and leakage of gases were not found even at the day 203 after start of operation. These results may correspond with the results of observation shown in the table 1.

What is claimed is:

1. An anti-corrosive agent for preventing corrosion of a heat exchange mechanism composed of a copper pipe for flowing heat exchange medium therethrough and a radiative member made of metal different from the copper pipe in quality and assembled in contact with the copper pipe for radiating heat transmitted from the copper pipe,
the anti-corrosive agent containing phenol-modified epoxy resin paint and aluminum powder as main components in a condition where the aluminum powder is uniformly mixed in the epoxy resin paint.

2. An anti-corrosive agent as set forth in claim 1, containing acetylacetone metallic salt acting as a surface-active agent.

3. An anti-corrosive agent for preventing corrosion of a heat exchange mechanism composed of a copper pipe for flowing heat exchange medium therethrough and a radiative member made of metal different from the copper pipe in quality and assembled in contact with the copper pipe for radiating heat transmitted from the copper pipe,
the anti-corrosive agent containing phenol-modified epoxy resin paint, benzotriazol and aluminum powder as main components in a condition where the aluminum powder and benzotriazol are uniformly mixed in the epoxy resin paint.

4. An anti-corrosive agent as set forth in claim 3, containing acetylacetone metallic salt acting as a surface-active agent.

5. An anti-corrosive agent as set forth in claim 1, wherein the phenol-modified epoxy resin paint is used to form an anti-corrosive membrane on the copper pipe and radiative member when coated thereon.

6. An anti-corrosive agent for preventing corrosion of a heat exchange mechanism composed of a copper pipe for flowing heat exchange medium therethrough and a plurality of aluminum fins assembled in contact with to the copper pipe for radiating heat transmitted from the copper pipe,
the anti-corrosive agent containing phenol-modified epoxy resin paint and aluminum powder as main components in a condition where the aluminum powder is uniformly mixed in the epoxy resin paint.

7. An anti-corrosive agent for preventing corrosion of a heat exchange mechanism composed of a copper pipe for flowing heat exchange medium therethrough and a plurality of stainless steal walls assembled in contact with to the copper pipe for radiating heat transmitted from the copper pipe,
the anti-corrosive agent containing phenol-modified epoxy resin paint and aluminum powder as main components in a condition where the aluminum powder is uniformly mixed in the epoxy resin paint.

8. An anti-corrosive agent for preventing corrosion of a heat exchange mechanism composed of a copper pipe for flowing heat exchange medium therethrough and a plurality of aluminum fins assembled in contact with to the copper pipe for radiating heat transmitted from the copper pipe,
the anti-corrosive agent containing phenol-modified epoxy resin paint, benzotriazol and aluminum powder as main components in a condition where the aluminum powder and benzotriazol are uniformly mixed in the epoxy resin paint.

9. An anti-corrosive agent for preventing corrosion of a heat exchange mechanism composed of a copper pipe for flowing heat exchange medium therethrough and a plurality of stainless steal walls assembled in contact with to the copper pipe for radiating heat transmitted from the copper pipe,
the anti-corrosive agent containing phenol-modified epoxy resin paint, benzotriazol and aluminum powder as main components in a condition where the aluminum powder and benzotriazol are uniformly mixed in the epoxy resin paint.
